(19) United States
(12) Patent Application Publication
(10) Pub. No.: US 2007/0036407 A1
(43) Pub. Date: Feb. 15, 2007

(54) PRINTING SYSTEM FOR ENDOSCOPE

(75) Inventor: Noriko OTA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/462,474

(22) Filed: Aug. 4, 2006

(30) Foreign Application Priority Data
Aug. 9, 2005 (JP) P2005-230538

(51) Int. Cl. G06K 9/00; H04N 1/60

(52) U.S. Cl. 382/128; 358/1.9

(57) ABSTRACT

An image printing system for an endoscope includes a printer, a print commander, a printer-information memory, a timer, and an image data memory. The printer prints an image, and the print commander commands the printer to print the image. The printer-information memory stores printer-information, including time-information that represents a required-time-period for the printer to print an image on a substrate. The timer measures an elapsed time from when the printer starts printing the image. The image data memory stores image data of the image commanded by the print commander until the required-time-period elapses. If the elapsed time from when the printer starts printing the image until when the print commander commands the printer to print a new image is shorter than the required-time-period, the printer can print the new image based on image data of the new image stored in the image data memory.

### BACKGROUND OF THE INVENTION

1. Field of the Invention

The present invention relates to an image printing system, especially to an image printing system used in an endoscope device

2. Description of the Related Art

In an endoscope device, a dye sublimation printer, which heats and sublimate inks for printing subject images based on generated image data, is widely used. Dye sublimation printers generally spend much time for printing, although they can print fine-grained images by setting ink densities closely due to heat control.

In printers used with an endoscope, image data transferred from the endoscope is temporarily stored in a memory. Generally, in endoscope operations, a plurality of subject images are printed on a printing paper, because images of subjects in slightly different positions are required to be compared to each other, and other reasons.

In a case where a plurality of subject images are printed on a printing paper sheet, especially where a dye sublimation printer is used for printing, the time for a printing operation is long. In such a case, when new image data are transferred to the printer and printing based on the image data is commanded, newly commanded images can not be printed during the printing operation. The reason is that image data newly transferred to the printer can not be stored in a memory in the printer. Therefore, an operator can not command printing during the printing operation, and operability for observing subject images when printing many images can be compromised.

On the other hand, recently, a general-purpose computer that can efficiently handle interactive data communications with a connected device, such as a printer, has been widely used. Such a computer can not only transfer huge amount of image data to a connected printer, but also can receive signals from the printer (for example, signals representing that there is an image that the printer can not print, although image data thereof are transferred from the computer to the printer). In such a case, the computer can temporarily store the image data of an image that can not be printed, and can re-transfer the image data later again to the printer, so that the printing operation can be carried out efficiently.

However, there are some restrictions on selecting medical instruments to be used, including an endoscope, because they generally need to be officially approved in terms of safety and hygiene. Therefore, in an endoscope system, the above mentioned superior computer may not always be introduced; that is, a printer is not always connected to an endoscope that can handle interactive data communications efficiently with a connected printer. When such an endoscope and a printer are used in an endoscope system, efficiency of operation may be decreased.

### SUMMARY OF THE INVENTION

Therefore, an objective of the present invention is to provide an image printing system with superior operability where commanded images are always printed.

An image printing system for an endoscope, according to the present invention, includes a printer, a print commander, a printer-information memory, a timer, and an image data memory. The printer prints an image, and the print commander commands the printer to print the image. The printer-information memory stores printer-information, including time-information that represents a required-time-period for the printer to print an image on a substrate. The timer measures an elapsed time from when the printer starts printing the image. The image data memory stores image data of the image commanded by the print commander until the required-time-period elapses. If the elapsed time from when the printer starts printing the image until when the print commander commands the printer to print a new image is shorter than the required-time-period, the printer can print the new image based on image data of the new image stored in the image data memory.

An endoscope system according to the present invention includes a subject image generator, a printer, a print commander, a printer-information memory, a timer, and an image data memory. The subject image generator generates a subject image. The printer prints the subject image, and the print commander commands the printer to print the subject image. The printer-information memory stores printer-information, including time-information that represents a required-time-period for the printer to print the subject image on a substrate. The timer measures an elapsed time from when the printer starts printing the image. The image data memory stores image data of the subject image commanded by the print commander until the required-time-period elapses. If the elapsed time from when the printer starts printing the image until when the print commander commands the printer to print a new image is shorter than the required-time-period, the printer can print the new subject image based on image data of the new subject image stored in the image data memory.

### BRIEF DESCRIPTION OF THE DRAWINGS

The present invention will be better understood from the description of the preferred embodiment of the invention set forth below together with the accompanying drawings, in which:

FIG. 1 is a block diagram of an endoscope system of the embodiment;

FIG. 2 is a view representing an example of a subject images printed by a printer; and

FIG. 3 is a flowchart of a print control routine representing a print control in an endoscope system.

### DESCRIPTION OF THE PREFERRED EMBODIMENT

Hereinafter, the preferred embodiment of the present invention is described with reference to the attached drawings.

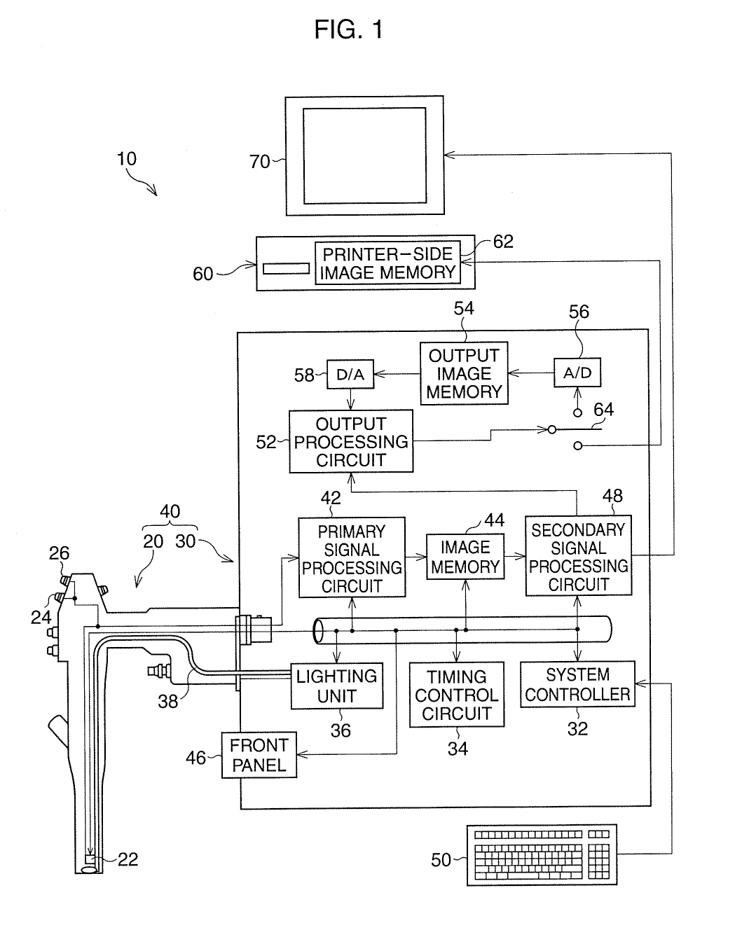

As shown in FIG. 1, an endoscope system 10 includes an endoscope 40 comprising a video scope 20 and a processor 30. The video scope 20 is used for photographing inside a body cavity. The processor 30 processes image signals transferred from the video scope 20. To the processor 30, a keyboard 50 for inputting order signals and so on, a dye sublimation type printer 60 for printing a subject image and so on, and a monitor 70 for displaying a subject image are connected. In the endoscope system 10, printers other than the printer 60 can be also used.

In the processor 30, a system controller 32 for controlling the entirety of the processor 30, a timing control circuit 34 for controlling signal processing timing in other circuits, a lighting unit 36 and so on, are provided. A light source (not shown) in the lighting unit 36 emits illuminating light under the control of the system controller 32. The illuminating light enters a light guide 38 after its intensity is adjusted. The illuminating light passes through the light guide 38 and is emitted to a body cavity as a subject from the end of the video scope 20.

The illuminating light reflected on a subject reaches a light-receiving surface of the CCD 22, then image signals representing a subject are generated by the CCD 22. Further, the luminance signal Y and color-difference signals Cb and Cr are generated by processing the image signals. The luminance signal Y and color-difference signals Cb and Cr are transferred to a primary signal processing circuit 42, and are stored in an image memory 44 after further processes are carried out in the primary signal processing circuit 42.

Image data including the luminance signal Y and color-difference signals Cb and Cr are output from the image memory 44 to the monitor 70 via a secondary signal processing circuit 48. As a result, a real-time moving image of a subject is displayed on the monitor 70.

A freeze button 24 is provided on the video scope 20. When the freeze button 24 is depressed while a moving image is displayed on the monitor 70, signals for generating a still image are transferred to the system controller 32, and image data of a still image are generated. Generated image data of a still image are stored in the image memory 44, and transferred to the secondary signal processing circuit 48. In the secondary signal processing circuit 48, predetermined processes are carried out on the image data, and the image data are transferred to the monitor 70. As a result, a still image is displayed on the monitor 70.

Further, a copy button 26 is provided on the video scope 20 adjacent to the freeze button 24. The copy button 26 is used for specifying an image to be printed by the printer 60, and is used for commanding the printing thereof. That is, when the copy button 26 is depressed while a moving image is displayed on the monitor 70, command signals to command the printer 60 to print a still image of the subject displayed when the copy button 26 is depressed, are transferred to the system controller 32.

As a result, image data of the still image specified by the copy button 26 are generated. The generated image data are stored in the image memory 44, and at the same time, the image data are transferred to an output processing circuit 52 via the secondary signal processing circuit 48. The image data are further transferred to the printer 60 via a conversion switch 64. In this manner, the subject image specified by the copy button 26 is printed.

In the processor 30, an output image memory 54 is provided. The output image memory 54 is a memory for storing a subject image temporarily. That is, in the output image memory 54, a subject image that is newly commanded to be printed while the printer 60 is printing a subject image is temporarily stored. If the printer 60 is already printing a subject image when the copy button 26 is depressed, the system controller 32 causes the conversion switch 64 to be connected to the output image memory 54 side.

Therefore, when the copy button 26 is depressed and a new subject image to be printed is specified while the printer 60 is printing, the image data of the subject image newly specified are transferred from the output processing circuit 52 to the output image memory 54 via an A/D converter 56, and stored. At this time, the image data are converted from analog signals to digital signals by the A/D converter 56, and then stored in the output image memory 54.

When printing of the subject image that is being printed at the time that the copy button 26 is depressed ends, the image data of the newly specified subject image stored in the output image memory 54 are soon transferred to the printer 60 via a D/A converter 58, the output processing circuit 52, and the conversion switch 64. As a result, after the subject image has been printed, the subject image newly specified becomes printable.

Image data transferred to the printer 60, are ordinarily converted from digital signals to analog signals by the D/A converter 58. However, if the printer 60 can process digital signals, the D/A converter 58 does not function, and image data are transferred to the printer 60 as digital signals, as explained below.

Note that the images stored in the image memory 44 when observation of subjects end can be printed by the operations of the keyboard 50 or a print button (not shown) provided on the surface of the printer 60. Further, a still image generated and stored by the depression of the freeze button 24 can be also printed by depressing the copy button 26.

In the printer 60, a printer-side image memory 62 for temporarily storing image data transferred from the output processing circuit 52 is provided. When a subject image based on the image data stored in the printer-side image memory 62 is printed on a printing paper (a substrate), the image data of the printed subject image are automatically deleted from the printer-side image memory 62 under a command from the control circuit (not shown) in the printer 60, and the image data newly transferred to the printer-side image memory 62 are stored, as explained below. In this manner, printing a subject image represented by the image data, and transferring and deleting image data, are repeated.

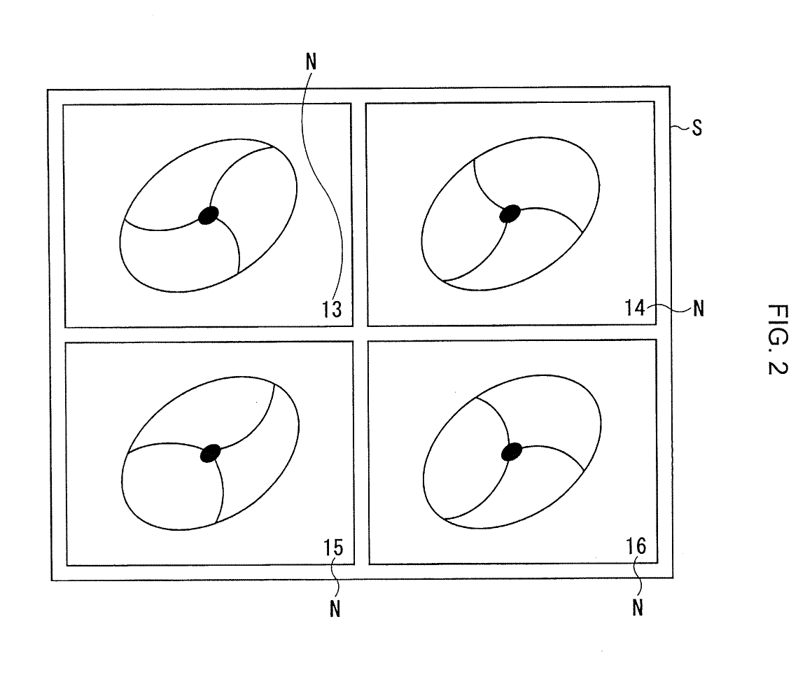

The printer 60 can print subject images in each of a plurality of divided areas of a printing area on a single printing paper sheet S (see FIG. 2). A print-image-number, that is, a maximum number of divided areas, and a maximum number of images printed on a single printing paper sheet S, can be selected from the choices previously set according to printers by the input operations of the keyboard 50. For example, in the printer 60, four subject images at a maximum to be printed on a single printing paper sheet S can be set; that is, the print-image-number can be set to “four”, as shown in FIG. 2.

Note that in the printer 60, setting the print-image-number to “one” is also possible; that is, it is possible to set only one subject image to be printed on a single printing paper sheet S, without dividing the printing area. Further, setting the print-image-number to “two”, “eight”, or so on is also possible, for dividing a printing area into two, eight, or so on. An image-identification-number “N” is assigned to each of the divided printing areas to identify subject images that are specified and commanded to be printed. Each image-identification-numbers “N” is automatically assigned in order of print commanding, displayed on the monitor 70 by each being superimposed on a subject image, and printed on the edge of each subject image when the copy button 26 is depressed.

Printer-information including the print-image-number is stored in a data memory (not shown) provided in the output processing circuit 52. The printer-information includes a required-time-period of the printer 60; that is, the time period required for the printer 60 to print the print-image-number of the images on a printing paper sheet S. The required-time-period is a value unique to a printer and unique to each print-image-number and so on; therefore, the required-time-period is set and stored for each kind of printer and for each print-image-number.

The printer-information further includes information on whether a printer, such as the printer 60, can process digital image signals or not. Therefore, whether the D/A converter 58 functions or not is determined based on the printer-information read by the system controller 32.

The printer-information is stored in the data memory not only for the printer 60, but also the other kinds of printers. Further, because the output image memory 54 for temporarily storing a subject image is not provided in the printer 60, but in the processor 30 of the endoscope 40, a plurality of printers may be used in the endoscope system 10 by connecting to the processor 30. Note that the required-time-period can vary according to the image quality to be printed, therefore the longest time period required for printing; that is, the time period for printing the highest quality image, is calculated beforehand and set as the required-time-period.

When the print-image-number is set to “four”, and the copy button 26 is depressed four times, four subject images to be printed are specified, and the four subject images are stored in the printer-side image memory 62; thus, the printer 60 automatically prints the four subject images, as exemplified in FIG. 2.

If while the printer 60 is printing subject images, the copy button 26 is further depressed; that is, for example, a fifth subject image is newly specified while the printer 60 is printing one of four subject images as exemplified in FIG. 2, the image data of the subject image newly specified is temporarily stored in the output image memory 54 until the required-time-period for printing the four subject images shown in FIG. 2 elapses. When the required-time-period required for printing the four subject images elapses, the image data of the new fifth subject image is transferred to the printer 60 and deleted from the output image memory 54, under a command from the system controller 32.

As maybe understood from the above description, when the copy button 26 is depressed, the state of whether the printer 60 is printing at the time or not should be determined. Therefore, a system clock (not shown) provided in the timing control circuit 34 measures an elapsed time from when the printing of a subject image by the printer 60 starts. Then, when the copy button 26 is depressed, an elapsed time from the starting time of printing to the time when the copy button 26 is depressed, and a predetermined required-time-period read from the data memory of the output processing circuit 52, are compared by the system controller 32.

As a result of the comparison, in the case when the elapsed time from the print starting time to the depression time of the copy button 26 is shorter than the required-time-period; that is, in the case when the copy button 26 is depressed while the printer 60 is printing, the system controller 32 switches the conversion switch 64 to the output image memory 54 setting.

On the other hand, in the case when the elapsed time is longer than the required-time-period, and the copy button 26 is depressed while the printer 60 is not printing, the system controller 32 switches the conversion switch 64 to the printer 60 setting, so that a subject image newly specified and commanded to be printed can be printed immediately.

The printer 60 automatically starts printing when the number of subject images to be printed is equal to the print-image-number. Therefore, a print-image-number of subject images are printed on the printing paper sheet S ordinarily, as exemplified in FIG. 2.

However, an operator may sometimes choose to start printing when the number of subject images to be printed is smaller than the set print-image-number; for example, after observing a series of subjects. In such a case, printing a smaller number of subject images than the set print-image-number is possible by command entry operations of the keyboard 50, or by a print switch (not shown) provided on the printer 60, for transferring command signals for commanding printing to the output processing circuit 52 via the secondary signal processing circuit 48.

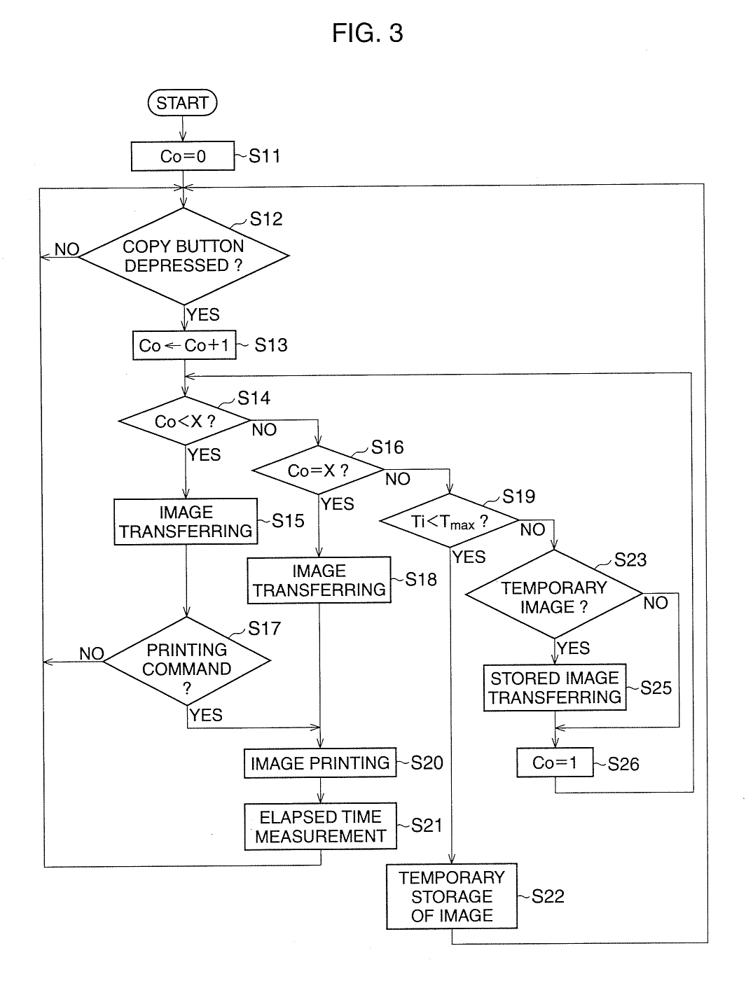

A print control routine (see FIG. 3) starts when the endoscope system 10 starts. At step S11, a subject image index “Co” is set to the initial value “0”, and the process proceeds to step S12. The subject image index “Co” represents a printing order of images to be printed on a single printing paper sheet S. At step S12, it is determined whether the copy button 26 is depressed and the printing of an image is being commanded, or not. When it is determined that the copy button 26 is depressed and printing is being commanded, the process proceeds to step S13. At step S13, the subject image index “Co” is incremented by “1”, and the process proceeds to step S14.

At step S14, it is determined whether the subject image index “Co” is smaller than the set print-image-number “X” or not, by the system controller 32. When it is determined that the subject image index “Co” is smaller than the print-image-number “X”, the process proceeds to step S15, and when it is determined that the subject image index “Co” is not smaller than the print-image-number “X”, the process proceeds to step S16.

At step S15, image data of the subject image specified at step S12, are transferred from the output processing circuit 52 to the printer-side image memory 62 in the printer 60, and the process proceeds to step S17. At step S17, whether printing is commanded or not by the operations of the keyboard 50 or the print switch is determined by the output processing circuit 52. When it is determined that printing is commanded, the process proceeds to step S20, and when it is not determined that printing is commanded, the process returns to step S12.

At step S16, it is determined whether the subject image index “Co” is equal to the print-image-number “X” or not. When it is determined that the subject image index “Co” is equal to the print-image-number “X”, the process proceeds to step S18, and when it is determined that the subject image index “Co” is not equal to the print-image-number “X”; that is, that the subject image index “Co” is higher than the print-image-number “X”, the process proceeds to step S19.

At step S18, image data of the subject image specified at step S12 are transferred from the output processing circuit 52 to the printer-side image memory 62, and the process proceeds to step S20. At step S20, a subject image represented by the image data temporarily stored in the printer-side image memory 62 is printed, and the process proceeds to step S21.

At step S21, an elapsed time “Ti” from the starting time of the printing at step S20 is reset by the timing control circuit 34, and measuring the elapsed time “Ti” starts. That is, at step S21, if the elapsed time “Ti” has already been measured, the elapsed time “Ti” is reset to “0”, and continuous to be measured. On the other hand, if the elapsed time “Ti” has not been measured, measuring the elapsed time “Ti” newly starts. After measuring the elapsed time “Ti” is continued or started at step S21, the process returns to step S12.

As explained above, in the print control routine, if the number of images print-commanded by the depression of the copy button 26 coincides with the print-image-number, the printer 60 automatically starts printing (steps S16, S18, and S20). Further, if the number of images print-commanded by the copy button 26 is lower than the print-image-number, when printing is commanded by the print switch or so on (steps S14, S15, and S17), printing an image starts (step S20).

At step S19, the elapsed time “Ti” has already started to be measured at step S21, and whether it is shorter than the required-time-period “Tmax” read from the data memory based on the type of the printer and set print-image-number “X” or not is determined. If it is determined that the elapsed time “Ti” is shorter than the required-time-period “Tmax”; that is, if specifying an image to be printed at step S12 is carried out while the printer 60 is printing, and printing the specified image can not be carried out soon, the process proceeds to step S22. On the other hand, if it is determined that the elapsed time “Ti” is longer than or equal to the required-time-period “Tmax”, the process proceeds to step S23. At step S22, image data of an image specified at step S12 is temporarily stored in the output image memory 54, and the process returns to step S12.

On the other hand, at step S23, it is determined whether the image data already temporarily stored in the output image memory 54 exists or not by the system controller 32. When it is determined that the image data temporarily stored in the output image memory 54 exists, the process proceeds to step S25, and when it is determined that the image data temporarily stored in the output image memory 54 does not exist, the process proceeds to step S26.

At step S25, the image data temporarily stored in the output image memory 54 is transferred to the printer-side image memory 62 via the output processing circuit 52 and so on, because the printer 60 is not printing at the time. Then the process proceeds to step S26. At step S26, the subject image index “Co” is set to “1”, and the process returns to step S14.

As explained above, image data of the subject image print-commanded at step S12 when the printer 60 is not printing are transferred to the printer 60 at step S15 or step S18, without being stored in the output image memory 54. Therefore, the image is soon printed.

On the other hand, image data of an image print-commanded while the printer 60 is printing; that is, image data of an image print-commanded within the required-time-period “Tmax” at step S12, are temporarily stored in the output image memory 54 (step S22). The reason is that the image can not be printed immediately. After the printer 60 finishes printing, the image data temporarily stored in the output image memory 54 are transferred to the printer 60 (step S25), and the images are printed.

As explained above, in the endoscope system 10 of the embodiment, when the number of images to be printed is equal to the print-image-number, the printer 60 automatically starts printing. When the number of images to be printed is higher than the print-image-number, all of the print-commanded images are printed smoothly and continuously, by temporarily storing image data of images print-commanded while the printer 60 is printing.

Therefore, a subject image print-commanded is always printed regardless of the command timing, even if the processor 30 can not handle interactive communications with the printer 60 (that is, even if the processor 30 can not receive signals representing that there is a subject image that the printer 60 can not print from the printer 60), and can not store image data thereof. Then, in the endoscope system 10 of the embodiment, efficient subject observation and printing of subject images are possible.

Note that an image printing system is not limited to the endoscope system 10. For example, a computer for specifying an image to be printed by the printer 60 can be used instead of the endoscope 40. Further, a printer adopted in an image printing system is not limited to the dye sublimation printer 60. For example, an inkjet printer can also be used.

The invention is not limited to that described in the preferred embodiment; namely, various improvements and changes may be made to the present invention without departing from the spirit and scope thereof.

The present disclosure relates to subject matter contained in Japanese Patent Application No. 2005-230538 (filed on Aug. 9, 2005) which is expressly incorporated herein, by reference, in its entirety.

1. An image printing system for an endoscope, comprising;
a printer that prints an image;
a print commander that commands said printer to print said image;
a printer-information memory that stores printer-information, including time-information that represents a required-time-period for said printer to print said image on a substrate;
a timer that measures an elapsed time from when said printer starts printing said image; and
an image data memory that stores image data of said image commanded by said print commander until said required-time-period elapses;
wherein if said elapsed time from when said printer starts printing said image until when said print commander commands said printer to print a new image is shorter than said required-time-period, said printer can print said new image based on image data of said new image stored in said image data memory.

2. The image printing system according to claim 1, further comprising an image controller that transfers said image data to said printer and deletes said image data stored in said image data memory, when said required-time-period elapses.

3. The image printing system according to claim 1, wherein said printer comprises a printer-side data memory that stores image data of said image commanded by said print commander, and a printer-side image deleter that deletes said image data after said printer prints said image.

4. The image printing system according to claim 1, wherein said printer comprises an print-image-number setter that sets a print-image-number that is a maximum number of images printed on a single said substrate, and wherein said print-image-number is included in said printer-information.

5. The image printing system according to claim 4, wherein said printer-information memory stores said required-time-period for said printer to print said print-image-number of said images on said single substrate, as said printer-information.

6. The image printing system according to claim 4, further comprising a number judge that determines whether a number of images commanded by said print commander to be printed is equal to said print-image-number or not, and when said number judge determines that said number of images is equal to said print-image-number, said printer automatically prints said images commanded by said print commander.

7. The image printing system according to claim 6, wherein said printer can print said images commanded by said print commander based on instructions from a user, regardless of a result of determination of said number judge.

8. The image printing system according to claim 1, wherein said printer is a dye sublimation printer.

9. An endoscope system comprising;
a subject image generator that generates a subject image;
a printer that prints said subject image;
a print commander that commands said printer to print said subject image;
a printer-information memory that stores printer-information, including time-information that represents a required-time-period for said printer to print said subject image on a substrate;
a timer that measures an elapsed time from when said printer starts printing said image; and
an image data memory that stores image data of said subject image commanded by said print commander until said required-time-period elapses;
wherein if said elapsed time from when said printer starts printing said image until when said print commander commands said printer to print a new subject image is shorter than said required-time-period, said printer can print said new subject image based on image data of said new subject image stored in said image data memory.

10. The endoscope system according to claim 9, further comprising an endoscope including said image data memory.

11. The endoscope system according to claim 10, further comprising an image data controller that transfers said image data to said printer and deletes said image data stored in said image data memory, when said required-time-period elapses.

12. The endoscope system according to claim 10, wherein said printer-information memory can store printer-information for a plurality of said printers, so that each said printer can be used with said endoscope.
